(19) United States
(12) Patent Application Publication
(10) Pub. No.: US 2006/0227865 A1
(43) Pub. Date: Oct. 12, 2006

(54) Unified architecture for inverse scanning for plurality of scanning scheme

(76) Inventor: Bhaskar Sherigar, Bangalore (IN)

Correspondence Address: MCANDREWS HELD & MALLOY, LTD, 500 WEST MADISON STREET, SUITE 3400, CHICAGO, IL, 60661, US

(21) Appl. No.: 11/092,347

(22) Filed: Mar. 29, 2005

(51) Int. Cl. H04N 11/04; H04N 11/02; H04N 7/12; H04B 1/66

(52) U.S. Cl. 375/240.03; 375/240.25; 375/240.18; 375/240.23

(57) ABSTRACT

Presented herein is a unified architecture for inverse scanning according to a plurality of scanning schemes. In one embodiment, there is presented a method for decoding video data. The method comprises receiving frequency coefficients; determining a scanning scheme associated with the frequency coefficients; receiving scaling factors associated with the frequency coefficients; ordering the scaling factors according to a first scanning scheme, wherein the scanning scheme associated with the frequency coefficients is the first scanning scheme; and ordering the scaling factors according to a second scanning scheme, wherein the scanning scheme associated with the frequency coefficients is the second scanning scheme.

### RELATED APPLICATIONS

[Not Applicable]

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

The JPEG (Joint Pictures Experts Group) and MPEG (Motion Picture Experts Group) standards were developed in response to the need for storage and distribution of images and video in digital form. JPEG is one of the primary image-coding formats for still images, while MPEG is one of the primary image-coding formats for motion pictures or video. The MPEG standard includes many variants, such as MPEG-1, MPEG-2, and Advanced Video Coding (AVC). Video Compact Discs (VCD) store video and audio content coded and formatted in accordance with MPEG-1 because the maximum bit rate for VCDs is 1.5 Mbps. The MPEG-1 video stream content on VCDs usually has bit-rate of 1.15 Mbps. MPEG-2 is the choice for distributing high quality video and audio over cable/satellite that can be decoded by digital set-top boxes. Digital versatile discs also use MPEG-2.

Both JPEG and MPEG use discrete cosine transformation (DCT) for image compression. The encoder divides images into 8×8 square blocks of pixels. The 8×8 square blocks of pixels are the basic blocks on which DCT is applied. DV uses block transform types 8×8, and 4×8. DCT separates out the high frequency and low frequency parts of the signal and transforms the input spatial domain signal into the frequency domain.

Low frequency components contain information to reconstruct the block to a certain level of accuracy whereas the high frequency components increase this accuracy. The size of the original 8×8 block is small enough to ensure that most of the pixels will have relatively similar values and therefore, on an average, the high frequency components have either zero or very small values.

The human visual system is much more sensitive to low frequency components than to high frequency components. Therefore, the high frequency components can be represented with less accuracy and fewer bits, without much noticeable quality degradation. Accordingly, a quantizer quantizes the 8×8 of frequency coefficients where the high frequency components are quantized using much bigger and hence much coarser quantization steps. The quantized matrix generally contains non-zero values in mostly lower frequency coefficients. Thus the encoding process for the basic 8×8 block works to make most of the coefficients in the matrix prior to run-level coding zero so that maximum compression is achieved. Different types of scanning are used so that the low frequency components are grouped together.

The scanning scheme varies depending on the compression standard that is used. For example, MPEG-2 uses one type of scanning for progressive pictures and another scanning for interlaced pictures. MPEG-4 uses three types of scanning schemes. Other standards, such as DV-25, may use another type of scanning.

After the scan, the matrix is represented efficiently using run-length coding with Huffman Variable Length Codes (VLC). Each run-level VLC specifies the number of zeroes preceding a non-zero frequency coefficient. The “run” value indicates the number of zeroes and the “level” value is the magnitude of the non-zero frequency coefficient following the zeroes. After all non-zero coefficients are exhausted, an end-of-block (EOB) is transmitted in the bit-stream.

Operations at the decoder happen in opposite order. The decoder decodes the Huffman symbols first, followed by inverse scanning, inverse quantization and IDCT. An inverse scanner inverses the scanning. However, the content received by the decoder can be scanned according to one of several different scanning schemes.

Additional parallel inverse scanners can support each additional scanning scheme. However, the foregoing would add considerable hardware or firmware to the decoder.

Further limitations and disadvantages of conventional and traditional approaches will become apparent to one of skill in the art, through comparison of such systems with the present invention as set forth in the remainder of the present application with reference to the drawings.

### BRIEF SUMMARY OF THE INVENTION

Presented herein is a unified architecture for inverse scanning according to a plurality of scanning schemes.

In one embodiment, there is presented a method for decoding video data. The method comprises receiving frequency coefficients; determining a scanning scheme associated with the frequency coefficients; receiving scaling factors associated with the frequency coefficients; ordering the scaling factors according to a first scanning scheme, wherein the scanning scheme associated with the frequency coefficients is the first scanning scheme; and ordering the scaling factors according to a second scanning scheme, wherein the scanning scheme associated with the frequency coefficients is the second scanning scheme.

In another embodiment, there is presented a circuit for decoding video data. The circuit comprises a processor and a memory. The memory is connected to the processor, and stores a plurality of instructions executable by the processor. The plurality of instructions are for receiving frequency coefficients; determining a scanning scheme associated with the frequency coefficients; receiving scaling factors associated with the frequency coefficients; ordering the scaling factors according to a first scanning scheme, wherein the scanning scheme associated with the frequency coefficients is the first scanning scheme; and ordering the scaling factors according to a second scanning scheme, wherein the scanning scheme associated with the frequency coefficients is the second scanning scheme.

In another embodiment, there is presented a decoder for decoding video data. The decoder comprises a VLC decoder and a circuit. The VLC decoder provides frequency coefficients. The circuit determines a scanning scheme associated with the frequency coefficients; receives scaling factors associated with the frequency coefficients; orders the scaling factors according to a first scanning scheme, wherein the scanning scheme associated with the frequency coefficients is the first scanning scheme; and orders the scaling factors according to a second scanning scheme, wherein the scanning scheme associated with the frequency coefficients is the second scanning scheme.

These and other advantages and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a block diagram describing compression of a video;

FIG. 2 is a block diagram describing exemplary scanning schemes;

FIG. 3 is block diagrams describing compression of a video;

FIG. 4 is a block diagram of a decoder configured in accordance with an embodiment of the present invention; and

FIG. 5 is a block diagram of an exemplary MPEG video decoder in accordance with an embodiment of the present invention.

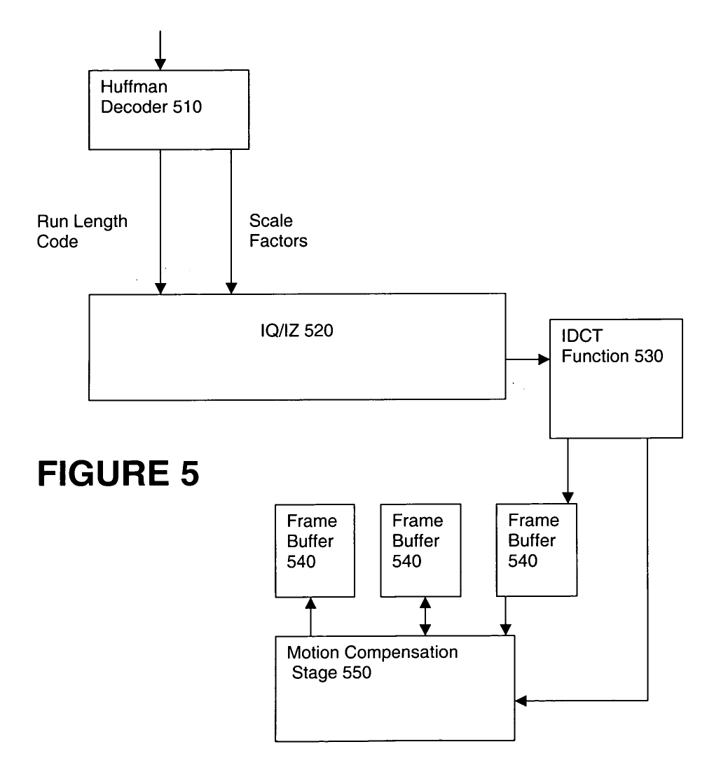

### DETAILED DESCRIPTION OF THE INVENTION

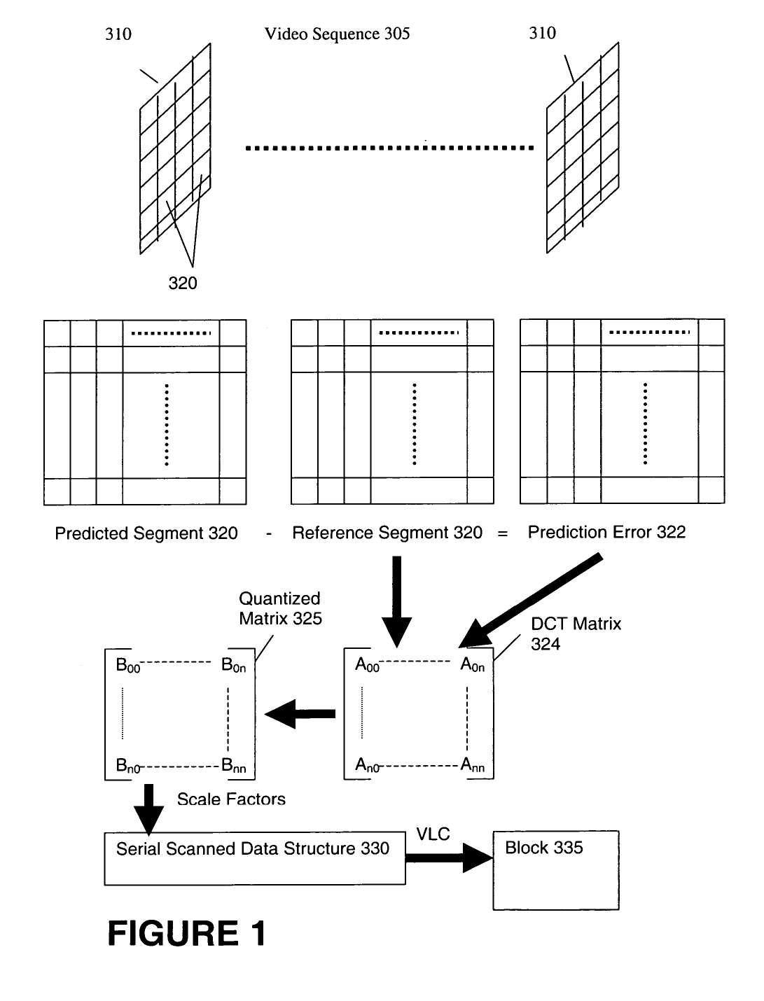

Referring now to FIG. 1, there is illustrated a block diagram describing the formatting of a video sequence 305 in accordance with an exemplary compression standard. A video sequence 305 comprises a series of pictures 310. In a progressive scan, the pictures 310 represent instantaneous images, while in an interlaced scan, the pictures 310 comprise two fields each of which represent a portion of an image at adjacent times. Each pictures comprises a two dimensional grid of pixels 315. The two-dimensional grid of pixels 315 is divided into 8×8 segments 320.

The pictures 310 can be considered as snapshots in time of moving objects. With pictures 310 occurring closely in time, it is possible to represent the content of one picture 310 based on the content of another picture 310, and information regarding the motion of the objects between the pictures 310.

Accordingly, blocks 320 of one picture 310 (a predicted frame) are predicted by searching segment 320 of a reference frame 310 and selecting the segment 320 in the reference frame most similar to the segment 320 in the predicted frame. A motion vector indicates the spatial displacement between the segment 320 in the predicted frame (predicted segment) and the segment 320 in the reference frame (reference segment). The difference between the pixels in the predicted segment 320 and the pixels in the reference segment 320 is represented by an 8×8 matrix known as the prediction error 322. The predicted segment 320 can be represented by the prediction error 322, and the motion vector.

In MPEG-2, the frames 310 can be represented based on the content of a previous frame 310, based on the content of a previous frame and a future frame, or not based on the content of another frame. In the case of segments 320 in frames not predicted from other frames, the pixels from the segment 320 are transformed to the frequency domain using DCT, thereby resulting in a DCT matrix 324. For predicted segments 320, the prediction error matrix is converted to the frequency domain using DCT, thereby resulting in a DCT matrix 324.

The segment 320 is small enough so that most of the pixels are similar, thereby resulting in high frequency coefficients of smaller magnitude than low frequency components. In a predicted segment 320, the prediction error matrix is likely to have low and fairly consistent magnitudes. Accordingly, the higher frequency coefficients are also likely to be small or zero. Therefore, high frequency components can be represented with less accuracy and fewer bits without noticeable quality degradation.

The coefficients of the DCT matrix 324 are quantized, using a higher number of bits to encode the lower frequency coefficients 324 and fewer bits to encode the higher frequency coefficients 324. The fewer bits for encoding the higher frequency coefficients 324 cause many of the higher frequency coefficients 324 to be encoded as zero. The foregoing results in a quantized matrix 325 and a set of scale factors.

As noted above, the higher frequency coefficients in the quantized matrix 325 are more likely to contain zero value. In the quantized frequency components 325, the lower frequency coefficients are concentrated towards the upper left of the quantized matrix 325, while the higher frequency coefficients 325 are concentrated towards the lower right of the quantized matrix 325. In order to concentrate the non-zero frequency coefficients, the quantized frequency coefficients 325 are scanned according to a scanning scheme, thereby forming a serial scanned data structure 330.

The serial scanned data structure 330 is encoded using variable length coding, thereby resulting in blocks 335. The VLC specifies the number of zeroes preceding a non-zero frequency coefficient. A “run” value indicates the number of zeroes and a “level” value is the magnitude of the nonzero frequency component following the zeroes. After all non-zero coefficients are exhausted, an end-of-block signal (EOB) indicates the end of the block 335.

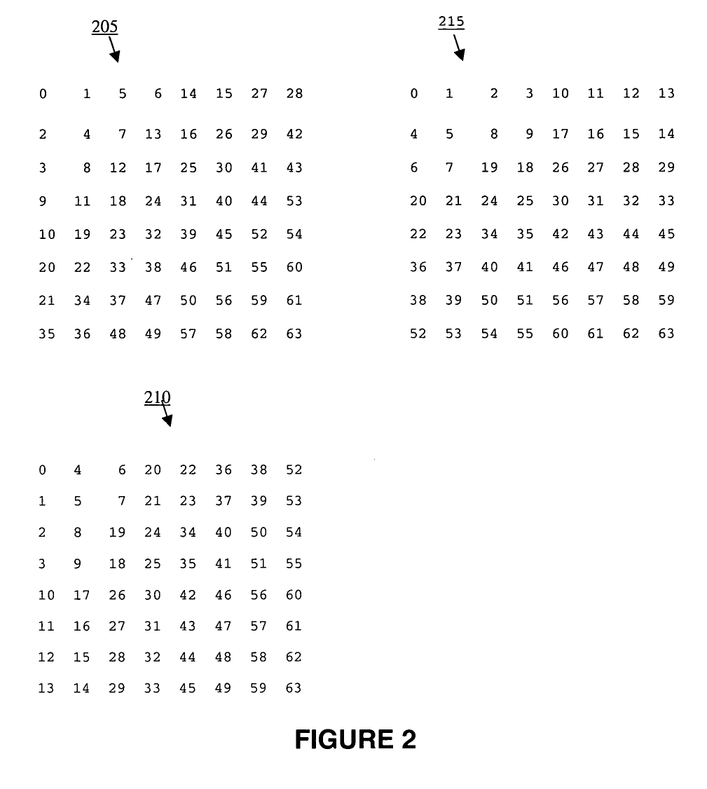

Referring now to FIG. 2, there are illustrated exemplary scanning schemes. The scanning scheme 205 is used by the MPEG-2 standard for scanning frequency coefficients for progressive pictures. The alternate scanning scheme 210 is used by the MPEG-2 standard for scanning frequency coefficients for interlaced pictures. Scanning Scheme 210 205 is also used by the DV-25 compression standard. Scanning schemes 210, 210 and 215 are all used by MPEG-4.

The positions in the matrices indicate increments in the horizontal and vertical frequency components, wherein left and top correspond to the lowest frequency components. The number in the matrices indicate the scanning order for the frequency coefficient thereat.

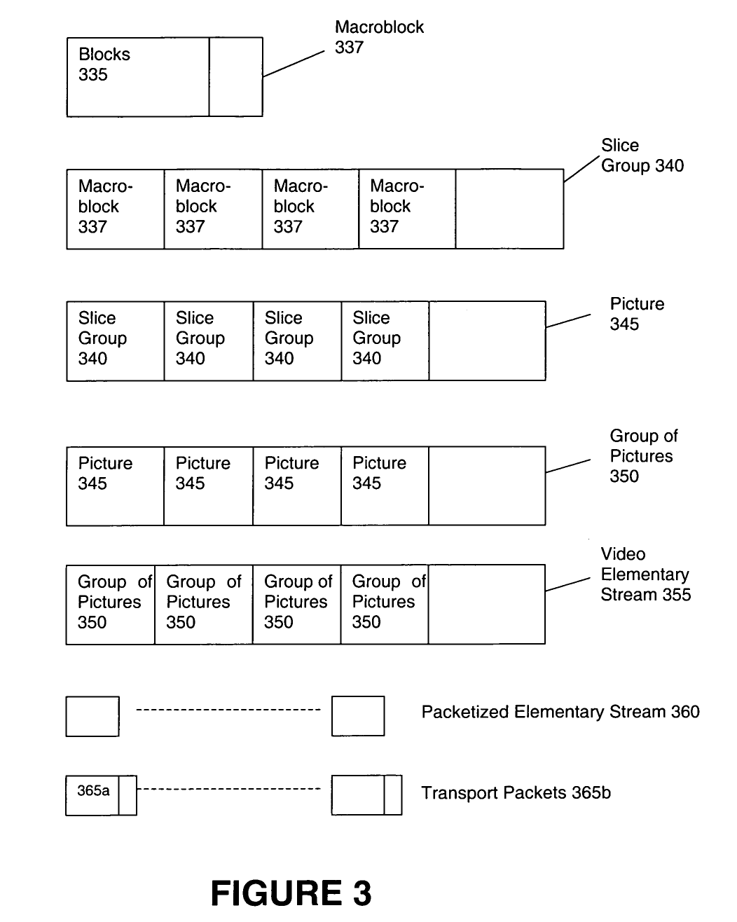

Continuing to FIG. 3, a block 335 forms the data portion of a macroblock structure 337. The macroblock structure 337 also includes additional parameters, including motion vectors.

Blocks 335 representing a frame are grouped into different slice groups 340. In MPEG-1, MPEG-2 and MPEG4 each slice group 340 contains contiguous blocks 335. The slice group 340 includes the macroblocks representing each block 335 in the slice group 340, as well as additional parameters describing the slice group. Each of the slice groups 340 forming the frame form the data portion of a picture structure 345. The picture 345 includes the slice groups 340 as well as additional parameters. The pictures are then grouped together as a group of pictures 350. Generally, a group of pictures includes pictures representing reference frames (reference pictures), and predicted frames (predicted pictures) wherein all of the predicted pictures can be predicted from the reference pictures and other predicted pictures in the group of pictures 350. The group of pictures 350 also includes additional parameters. Groups of pictures are then stored, forming what is known as a video elementary stream 355.

The video elementary stream 355 is then packetized to form a packetized elementary sequence 360. Each packet is then associated with a transport header 365a, forming what are known as transport packets 365b.

Referring now to FIG. 3, there is illustrated a block diagram of an exemplary decoder for decoding compressed video data, configured in accordance with an embodiment of the present invention. A processor, that may include a CPU 490, reads a stream of transport packets 365b (a transport stream) into a transport stream buffer 432 within an SDRAM 430. The data is output from the transport stream presentation buffer 432 and is then passed to a data transport processor 435. The data transport processor then demultiplexes the MPEG transport stream into its PES constituents and passes the audio transport stream to an audio decoder 460 and the video transport stream to a video transport processor 440. The video transport processor 440 converts the video transport stream into a video elementary stream and provides the video elementary stream to an MPEG video decoder 445 that decodes the video. The audio data is sent to the output blocks and the video is sent to a display engine 450. The display engine 450 is responsible for and operable to scale the video picture, render the graphics, and construct the complete display among other functions. Once the display is ready to be presented, it is passed to a video encoder 455 where it is converted to analog video using an internal digital to analog converter (DAC). The digital audio is converted to analog in the audio digital to analog converter (DAC) 465.

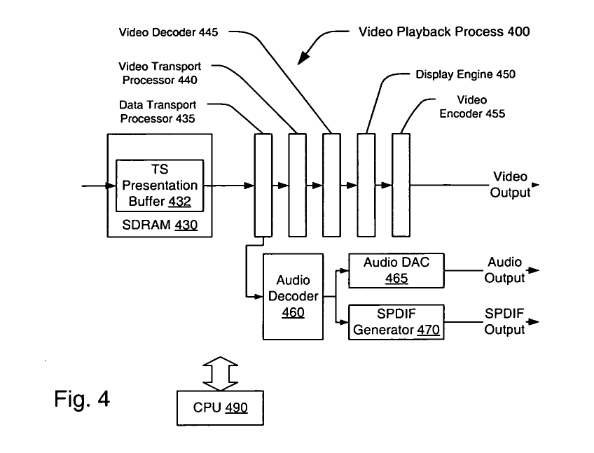

Referring now to FIG. 4, there is illustrated a block diagram of an MPEG video decoder 445 in accordance with an embodiment of the present invention. The MPEG video decoder 445 receives a block 335 that is encoded as variable length data with a variable length code. A Huffman VLC decoder 510 decodes the variable length code, resulting in a set of scale factors and the quantized and scanned frequency coefficients with run-length coding.

An inverse quantizer/inverse scanner (IQ/IZ) 520 provides dequantized frequency coefficients, associated with the appropriate frequencies to the IDCT function 530. As noted, the frequency coefficients can be scanned according to any one of a number of different scanning schemes. The particular scanning scheme used can be determined based on the type of picture and type of compression used. For example, if the compression standard MPEG-2, and the pictures are progressive, then the scanning scheme used is scanning scheme 205. If the compression standard is DV-25, then the scanning scheme used is scanning scheme 210. If the compression standard is MPEG-2 and the pictures are interlaced, then the scanning scheme used is scanning scheme 210.

Accordingly, depending on the particular scanning scheme 205 or 210, the IQ/IZ 520 creates a data structure with the scale factors. Each of the scale factors are associated with a particular one of the quantized frequency coefficients. In the data structure created by the IQ/IZ 520, the scale factors for the quantized frequency coefficients are ordered according to the scanning scheme used for scanning the frequency coefficients. The frequency coefficients are then multiplied by the data structure in dot product fashion.

For example, where the quantized frequency coefficients are B₀₀, B₀₁, . . . , B₀₇, B₁₀, B₁₁, . . . , B₁₇, . . . B₇₀, B₇₁, . . . , B₇₇, the scale factors are S₀₀, S₀₁, . . . , S₀₇, S₁₀, S₁₁, . . . , S₁₇, . . . S₇₀, S₇₁, . . . , S₇₇, and scanning scheme 205 is used, the quantized frequency coefficients are received in the following order (top, left is first/bottom, right is last):

| | | | | | | | |
|---|---|---|---|---|---|---|---|
| B₀₀ | B₀₁ | B₁₀ | B₂₀ | B₁₁ | B₀₂ | B₀₃ | B₁₂ |
| B₂₁ | B₃₀ | B₄₀ | B₃₁ | B₂₂ | B₁₃ | B₀₄ | B₀₅ |
| B₁₄ | B₂₃ | B₃₂ | B₄₁ | B₅₀ | B₆₀ | B₅₁ | B₄₂ |
| B₃₃ | B₂₄ | B₁₅ | B₀₆ | B₀₇ | B₁₆ | B₂₅ | B₃₄ |
| B₄₃ | B₅₂ | B₆₁ | B₇₀ | B₁₇ | B₂₆ | B₃₅ | B₄₄ |
| B₅₃ | B₆₂ | B₇₁ | B₇₂ | B₆₃ | B₅₄ | B₄₅ | B₃₆ |
| B₂₇ | B₃₇ | B₄₆ | B₅₅ | B₆₄ | B₇₃ | B₇₄ | B₆₅ |
| B₅₆ | B₄₇ | B₅₇ | B₆₆ | B₇₅ | B₇₆ | B₆₇ | B₇₇ |

Accordingly, the IQ/IZ 520 orders the scale factors as:

| | | | | | | | |
|---|---|---|---|---|---|---|---|
| S₀₀ | S₀₁ | S₁₀ | S₂₀ | S₁₁ | S₀₂ | S₀₃ | S₁₂ |
| S₂₁ | S₃₀ | S₄₀ | S₃₁ | S₂₂ | S₁₃ | S₀₄ | S₀₅ |
| S₁₄ | S₂₃ | S₃₂ | S₄₁ | S₅₀ | S₆₀ | S₅₁ | S₄₂ |
| S₃₃ | S₂₄ | S₁₅ | S₀₆ | S₀₇ | S₁₆ | S₂₅ | S₃₄ |
| S₄₃ | S₅₂ | S₆₁ | S₇₀ | S₁₇ | S₂₆ | S₃₅ | S₄₄ |
| S₅₃ | S₆₂ | S₇₁ | S₇₂ | S₆₃ | S₅₄ | S₄₅ | S₃₆ |
| S₂₇ | S₃₇ | S₄₆ | S₅₅ | S₆₄ | S₇₃ | S₇₄ | S₆₅ |
| S₅₆ | S₄₇ | S₅₇ | S₆₆ | S₇₅ | S₇₆ | S₆₇ | S₇₇ |

The quantized frequency coefficients are then multiplied by the scale factors in dot-product fashion, resulting in:

| | | | | | | | |
|---|---|---|---|---|---|---|---|
| SB₀₀ | SB₀₁ | SB₁₀ | SB₂₀ | SB₁₁ | SB₀₂ | SB₀₃ | SB₁₂ |
| SB₂₁ | SB₃₀ | SB₄₀ | SB₃₁ | SB₂₂ | SB₁₃ | SB₀₄ | SB₀₅ |
| SB₁₄ | SB₂₃ | SB₃₂ | SB₄₁ | SB₅₀ | SB₆₀ | SB₅₁ | SB₄₂ |
| SB₃₃ | SB₂₄ | SB₁₅ | SB₀₆ | SB₀₇ | SB₁₆ | SB₂₅ | SB₃₄ |
| SB₄₃ | SB₅₂ | SB₆₁ | SB₇₀ | SB₁₇ | SB₂₆ | SB₃₅ | SB₄₄ |
| SB₅₃ | SB₆₂ | SB₇₁ | SB₇₂ | SB₆₃ | SB₅₄ | SB₄₅ | SB₃₆ |
| SB₂₇ | SB₃₇ | SB₄₆ | SB₅₅ | SB₆₄ | SB₇₃ | SB₇₄ | SB₆₅ |
| SB₅₆ | SB₄₇ | SB₅₇ | SB₆₆ | SB₇₅ | SB₇₆ | SB₆₇ | SB₇₇ |

In another example, where the quantized frequency coefficients are B₀₀, B₀₁, . . . , B₀₇, B₁₀, B₁₁, . . . , B₁₇, . . . B₇₀, B₇₁, . . . , B₇₇, the scale factors are S₀₀, S₀₁, . . . , S₀₇, S₁₀, S₁₁, . . . , S₁₇, . . . S₇₀, S₇₁, . . . , S₇₇, and scanning scheme 210 is used, the quantized frequency coefficients are received in the following order (top, left is first/bottom, right is last):

| | | | | | | | |
|---|---|---|---|---|---|---|---|
| B₀₀ | B₁₀ | B₂₀ | B₃₀ | B₀₁ | B₁₁ | B₀₂ | B₁₂ |
| B₂₁ | B₃₁ | B₄₀ | B₅₀ | B₆₀ | B₇₀ | B₇₁ | B₆₁ |
| B₅₁ | B₄₁ | B₃₂ | B₂₂ | B₀₃ | B₁₃ | B₀₄ | B₁₄ |
| B₂₃ | B₃₃ | B₄₂ | B₅₂ | B₆₂ | B₇₂ | B₄₃ | B₅₃ |
| B₆₃ | B₇₃ | B₂₄ | B₃₄ | B₀₅ | B₁₅ | B₀₆ | B₁₆ |
| B₂₅ | B₃₅ | B₄₄ | B₅₄ | B₆₄ | B₇₄ | B₄₅ | B₅₅ |
| B₆₅ | B₇₅ | B₂₆ | B₃₆ | B₀₇ | B₁₇ | B₂₇ | B₃₇ |
| B₄₆ | B₅₆ | B₆₆ | B₇₆ | B₄₇ | B₅₇ | B₆₇ | B₇₇ |

Accordingly, the IQ/IZ 520 orders the scale factors as:

| | | | | | | | |
|---|---|---|---|---|---|---|---|
| S₀₀ | S₁₀ | S₂₀ | S₃₀ | S₀₁ | S₁₁ | S₀₂ | S₁₂ |
| S₂₁ | S₃₁ | S₄₀ | S₅₀ | S₆₀ | S₇₀ | S₇₁ | S₆₁ |
| S₅₁ | S₄₁ | S₃₂ | S₂₂ | S₀₃ | S₁₃ | S₀₄ | S₁₄ |
| S₂₃ | S₃₃ | S₄₂ | S₅₂ | S₆₂ | S₇₂ | S₄₃ | S₅₃ |
| S₆₃ | S₇₃ | S₂₄ | S₃₄ | S₀₅ | S₁₅ | S₀₆ | S₁₆ |
| S₂₅ | S₃₅ | S₄₄ | S₅₄ | S₆₄ | S₇₄ | S₄₅ | S₅₅ |
| S₆₅ | S₇₅ | S₂₆ | S₃₆ | S₀₇ | S₁₇ | S₂₇ | S₃₇ |
| S₄₆ | S₅₆ | S₆₆ | S₇₆ | S₄₇ | S₅₇ | S₆₇ | S₇₇ |

The quantized frequency coefficients are then multiplied by the scale factors in dot-product fashion resulting in:

| | | | | | | | |
|---|---|---|---|---|---|---|---|
| SB₀₀ | SB₁₀ | SB₂₀ | SB₃₀ | SB₀₁ | SB₁₁ | SB₀₂ | SB₁₂ |
| SB₂₁ | SB₃₁ | SB₄₀ | SB₅₀ | SB₆₀ | SB₇₀ | SB₇₁ | SB₆₁ |
| SB₅₁ | SB₄₁ | SB₃₂ | SB₂₂ | SB₀₃ | SB₁₃ | SB₀₄ | SB₁₄ |
| SB₂₃ | SB₃₃ | SB₄₂ | SB₅₂ | SB₆₂ | SB₇₂ | SB₄₃ | SB₅₃ |
| SB₆₃ | SB₇₃ | SB₂₄ | SB₃₄ | SB₀₅ | SB₁₅ | SB₀₆ | SB₁₆ |
| SB₂₅ | SB₃₅ | SB₄₄ | SB₅₄ | SB₆₄ | SB₇₄ | SB₄₅ | SB₅₅ |
| SB₆₅ | SB₇₅ | SB₂₆ | SB₃₆ | SB₀₇ | SB₁₇ | SB₂₇ | SB₃₇ |
| SB₄₆ | SB₅₆ | SB₆₆ | SB₇₆ | SB₄₇ | SB₅₇ | SB₆₇ | SB₇₇ |

The foregoing results in dequantized frequency coefficients. The dequantized frequency coefficients are then provided to the IDCT function 530. Where the block decoded corresponds to a reference frame, the output of the IDCT is the pixels forming a segment 320 of the frame. The IDCT provides the pixels in a reference frame 310 to a reference frame buffer 540. The reference frame buffer combines the decoded blocks 535 to reconstruct a frame 310. The frames stored in the frame buffer 540 are provided to the display engine.

Where the block 335 decoded corresponds to a predicted frame 310, the output of the IDCT is the prediction error with respect to a segment 320 in a reference frame(s) 310. The IDCT provides the prediction error to the motion compensation stage 550. The motion compensation stage 550 also receives the motion vector(s) from the parameter decoder 516. The motion compensation stage 550 uses the motion vector(s) to select the appropriate segments 320 blocks from the reference frames 310 stored in the reference frame buffer 540. The segments 320 from the reference picture(s), offset by the prediction error, yield the pixel content associated with the predicted segment 320. Accordingly, the motion compensation stage 550 offsets the segments 320 from the reference block(s) with the prediction error, and outputs the pixels associated of the predicted segment 320. The motion compensation 550 stage provides the pixels from the predicted block to another frame buffer 540. Additionally, some predicted frames are reference frames for other predicted frames. In the case where the block is associated with a predicted frame that is a reference frame for other predicted frames, the decoded block is stored in a reference frame buffer 540.

The embodiments described herein may be implemented as a board level product, as a single chip, application specific integrated circuit (ASIC), or with varying levels of the decoder system integrated with other portions of the system as separate components. The degree of integration of the decoder system will primarily be determined by the speed and cost considerations. Because of the sophisticated nature of modern processor, it is possible to utilize a commercially available processor, which may be implemented external to an ASIC implementation. Alternatively, if the processor is available as an ASIC core or logic block, then the commercially available processor can be implemented as part of an ASIC device wherein certain functions can be implemented in firmware.

While the invention has been described with reference to certain embodiments, it will be understood by those skilled in the art that various changes may be made and equivalents may be substituted without departing from the scope of the invention. In addition, many modifications may be made to adapt particular situation or material to the teachings of the invention without departing from its scope. Therefore, it is intended that the invention not be limited to the particular embodiment(s) disclosed, but that the invention will include all embodiments falling within the scope of the appended claims.

1. A method for decoding video data, said method comprising:
receiving frequency coefficients;
determining a scanning scheme associated with the frequency coefficients;
receiving scaling factors associated with the frequency coefficients; and
ordering the scaling factors according to a first scanning scheme, wherein the scanning scheme associated with the frequency coefficients is the first scanning scheme;
ordering the scaling factors according to a second scanning scheme, wherein the scanning scheme associated with the frequency coefficients is the second scanning scheme.

2. The method of claim 1, wherein determining the scanning scheme further comprises:
determining a picture type for the frequency coefficients.

3. The method of claim 1, wherein determining the scanning scheme further comprises:
determining a compression standard associated with the coefficients.

4. The method of claim 3, wherein the compression standard is selected from a group consisting of MPEG-1, MPEG-2, MPEG-4 and DV-25.

5. The method of claim 1, further comprising:
multiplying the frequency coefficients with the scaling factors, thereby resulting in dequantized frequency coefficients.

6. The method of claim 5, further comprising:
transforming the dequantized frequency coefficients to a spatial domain.

7. The method of claim 1, further comprising:
ordering the scaling factors according to a third scanning scheme, wherein the scanning scheme associated with the frequency coefficients is the third scanning scheme.

8. A circuit for decoding video data, said circuit comprising:
a processor; and
a memory connected to the processor, said memory storing a plurality of instructions executable by the processor, said plurality of instructions for:
receiving frequency coefficients;
determining a scanning scheme associated with the frequency coefficients;
receiving scaling factors associated with the frequency coefficients;
ordering the scaling factors according to a first scanning scheme, wherein the scanning scheme associated with the frequency coefficients is the first scanning scheme; and
ordering the scaling factors according to a second scanning scheme, wherein the scanning scheme associated with the frequency coefficients is the second scanning scheme.

9. The circuit of claim 8, wherein determining the scanning scheme further comprises:
determining a picture type for the frequency coefficients.

10. The circuit of claim 8, wherein determining the scanning scheme further comprises:
determining a compression standard associated with the coefficients.

11. The circuit of claim 10, wherein the compression standard is selected from a group consisting of MPEG-2 and DV-25.

12. The circuit of claim 8, wherein the plurality of instructions is also for:
multiplying the frequency coefficients with the scaling factors, thereby resulting in dequantized frequency coefficients.

13. The circuit of claim 12, wherein the plurality of instructions is also for:
transforming the dequantized frequency coefficients to a spatial domain.

14. The circuit of claim 8, wherein the plurality of instructions is also for:
ordering the scaling factors according to a third scanning scheme, wherein the scanning scheme associated with the frequency coefficients is the third scanning scheme.

15. A decoder for decoding video data, said decoder comprising:
a Huffman decoder for providing frequency coefficients;
a circuit for:
determining a scanning scheme associated with the frequency coefficients;
receiving scaling factors associated with the frequency coefficients;
ordering the scaling factors according to a first scanning scheme, wherein the scanning scheme associated with the frequency coefficients is the first scanning scheme; and
ordering the scaling factors according to a second scanning scheme, wherein the scanning scheme associated with the frequency coefficients is the second scanning scheme.

16. The circuit of claim 15, wherein determining the scanning scheme further comprises:
determining a picture type for the frequency coefficients.

17. The circuit of claim 15, wherein determining the scanning scheme further comprises:
determining a compression standard associated with the coefficients.

18. The circuit of claim 15, wherein the compression standard is selected from a group consisting of MPEG1-1 MPEG-2, MPEG-4 and DV-25.

19. The circuit of claim 15, wherein the circuit multiplies the frequency coefficients with the scaling factors, thereby resulting in dequantized frequency coefficients.

20. The circuit of claim 19, further comprising:
another circuit for transforming the dequantized frequency coefficients to a spatial domain.

21. The circuit of claim 15, further comprising:
another circuit for ordering the scaling factors according to a third scanning scheme, wherein the scanning scheme associated with the frequency coefficients is the third scanning scheme.
